(19) United States
(12) Patent Application Publication
(10) Pub. No.: US 2005/0080729 A1
(43) Pub. Date: Apr. 14, 2005

(54) System for accessing account sufficiency information to enhance the success rate for clearing checks

(76) Inventors: Stephen J. Shaper, Houston, TX (US); Matthew J. Clyne, Houston, TX (US)

Correspondence Address: SUE Z. SHAPER, P.C., 1800 WEST LOOP SOUTH, SUITE 1450, HOUSTON, TX, 77027, US

(21) Appl. No.: 10/951,348

(22) Filed: Sep. 28, 2004

Related U.S. Application Data
(60) Provisional application No. 60/506,869, filed on Sep. 29, 2003.

(51) Int. Cl. G06F 17/60

(52) U.S. Cl. 705/39; 705/42

(57) ABSTRACT

An improved system for accessing account sufficiency information relating to checks, in order to enhance the success rate for clearing bank checks, including receiving at a service provider electronic records from a plurality of sources and ascertaining by the service provider account sufficiency information from the participating banks in regard to at least 1000 checks per business day, on average, relating to said records. The system may include economies of scale such as at least partial automation of callers, opening service provider accounts at banks and/or batching checks for callers from different sources or holders.

### FIELD OF THE INVENTION

This invention relates to the field of enhancing the success rate for clearing checks or of minimizing check returns, and more particularly, to improved systems for accessing account sufficiency information in order to enhance the success rate and minimize returns.

### BACKGROUND OF THE INVENTION

Tel entities (merchants that sell by telephone), Web entities (merchants that sell by Web) and collection agencies are prime examples of entities that acquire, directly or indirectly, a monetary interest or right in a high risk check in the course of their business, a check where there is a significant or higher than normal risk of the check being returned. More particularly, there is a greater than normal risk of either insufficient funds or of an invalid account being associated with many checks held by these entities.

Web and Tel merchants are referred to as non-face-to-face merchants. Web entities acquire “checks” by mail or by a non-face-to-face authorization over the Web by a correspondent to create a check (paper or electronic) on an account to cover a transaction for goods or services. Tel entities likewise acquire checks by mail or by non-face-to-face authorization over the telephone by a correspondent to create a check (paper or electronic) on a account to cover a transaction for goods or services. Statistics show that there is a significantly heightened risk of returned checks in the case of checks created by Tel and Web merchants. As a result, Web and Tel merchants are asked to pay significantly higher fees to commercial check verification and/or guarantee services, frequently rendering such services commercially unfeasible.

Collection agencies typically acquire checks by purchase, at a discount. Usually the checks have already been returned at least once. Historically, the checks may have been returned at least twice and some paper checks many times. The past history of the checks and the discount paid reflect the high likelihood of further “returns”. A percentage of banks, roughly 60 percent today (accounting for 30 to 45 percent of the checks,) such banks being referred to herein as “participating banks”, provide the service of responding to an inquiry over the phone as to whether a given account in their bank has sufficient funds to cover a given check at the time of inquiry. However, no “hold” is or can be placed on the funds through this service. Each bank sets up its own inquiry routine, requirements and procedures. Nothing is standardized. Some banks charge for the privilege. Some banks only respond to a caller if the caller itself already has an account with the bank. Some banks permit a plurality of inquiries, in regard to a plurality of checks, in one phone call. Most of the calls according to common practice are time consuming.

Tel merchants, Web merchants and collection agencies have historically utilized, on a selected basis, the bank phone inquiry services. However, because the service is exceptionally slow and cumbersome to access in general, including difficulties in discerning the correct number and procedure, it has historically been cost effective only for “large” checks, where the amount at risk justifies the cost of the effort. It is estimated that the cost to individual check holders for regularly utilizing a bank phone inquiry service is at least $2 per check, and is more than likely well over $3 per check.

If it were determined by a call to a bank that there would or would not be sufficient funds in an account at that moment to cover an amount of a check, Tel and Web merchants, on the one hand, and collection agencies, on the other hand, would tend to utilize the information differently, or in a different prioritized order. A collection agency, assuming it had already purchased the check, would likely attempt to clear the check as soon as possible. On the other hand, Tel and Web merchants might have waited, before their de facto acceptance of the check by directing a shipment of goods or a provision of services, until they could at least confirm no negative report of insufficient funds or invalid account. But collection agencies could also use the information, if timely and cost effective, in pricing their “purchase.” And, Web and Tel merchants could also use the information to present accepted checks.

Check verification and/or guarantee services historically do not regularly utilize the bank inquiry system in regard to a given check before making their approval/disapproval rating. These services are provided for typical “face-to-face” merchants (not Tel or Web merchants) comprising the majority of commerce. A check verification and/or guarantee provider responds within seconds to individual inquiries in real time with an approval/disapproval rating in regard to a check submission. The verification and/or guarantee service relies on its own (and/or other third party) databases, usually proprietary databases, negative and positive, as well as upon elaborate prediction algorithms. Only in a rare circumstance might a check verification/guarantee service avail itself of the possibility of calling a bank. Such might happen upon the occasion of a very large check. Such an inquiry sought in real time would delay a merchant transaction for a period of minutes (rather than seconds). A delay of minutes is usually considered by a merchant to be unacceptable. And again, enough banks do not participate that the procedure could not be relied on in general. The check verification and/or guarantee services, thus, rely on their own databases, giving them speed and completeness and accuracy for the large majority of cases. For a minority of riskier cases, such as non-face-to-face merchants like Web and Tel merchants, where the risk of bad checks escalates, the proprietary database system becomes less reliable and check verification and/or guarantee services typically respond by pricing their product out of the ballpark.

A new VISA POS system has been propounded for checks. That system inquires electronically as to the sufficiency of funds in an account for a merchant prior to the acceptance of the check by the merchant. That system, like the system for debit cards, also puts a hold on the funds and operates in real time for individual inquiries. That system is available only for face-to-face checks, not non-face-to-face checks.

No one to date has well met the real needs of the Web and Tel merchant and/or the collection agencies.

To the extent non-face-to-face merchant checks are handled at all, check verification and/or guarantee services might batch the checks for night processing, thereby somewhat reducing processing costs. (Sometimes even in the case of regular “face-to-face” merchants, checks of small denomination are also batched for night processing to reduce costs.) In both cases, however, notwithstanding the absence of the “real time” requirement to respond in seconds, the check verification/guarantee services rely on their databases. This is true even where speed of only a few seconds is not important. Regular, systemized inquiry is not made of banks, presumably for the above reasons of slowness, lack of completeness, lack of standardization and the high level of confidence developed in the proprietary databases and algorithms as applied to face-to-face checks.

The only instance, to the inventors' knowledge, in which a check guarantee and/or verification service has been known to regularly contact participating banks has been in an “after the fact” scenario in regard to large checks, where after the service rendered their “approval/disapproval” in regard to a large check, they attempted a bank inquiry to update, if possible, the accuracy of their own database.

One recent trend in the banking system can potentially aid holders of high risk checks. While historically checks have been presented and cleared through a physical paper presentation process, an elaborate mechanism utilizing Federal Reserve banks and/or specialized banks and occurring over several days, in the recent years the banking system has been increasingly relying on, and moving more fully toward, a system of electronic clearing. Electronic clearing is rapid. Presentment and clearing can take place within a very short period of time.

Electronic clearing has implications for the instant invention. For checks for which there is a significant likelihood or risk of “return”, the capacity to electronically clear a check quickly after a “night time” determination of the present existence of sufficient funds in a valid account to cover the check, is a valuable aid.

Other recent trends are not so favorable. A factor potentially leading to Web and Tel entities, and collection agencies, incurring even greater loses, and thereby lending increasing importance to the instant invention, is the growing pressure by regulators to limit the total number of times a check can be presented to a bank. E.g., the total number of representments, paper and electronic, is currently limited to two. The number of representments is being limited because Return Deposit Financial Institutions (i.e. the payees or the banks upon which the checks are drafted) have complained aggressively about the cost of processing a high number of checks that are repeatedly represented and returned. Furthermore, consumers have aggressively complained in regard to the resultingly high number of accumulated fees against them from the constant representing of a check for which there is not sufficient funds.

Hence, while historically a collection agency depended upon the procedure of representing a paper check over and over until it eventually cleared, now the collection agency, as well as Tel and Web merchants, is forced to take even greater risks in accepting/acquiring checks, since the frequency of permitted representations is severely limited. It should be appreciated that the cost of collecting on a check that can no longer be presented rises significantly. Therefore, it is more financially beneficial than ever to such entities if they could make a more informed decision in regard to the timing for the presentment of a check, as long as the more informed decision is associated with an acceptable cost.

As discussed above, the ability to determine the sufficiency of finds in a valid account, by phone or electronic contact with a bank, has not been systematically and extensively utilized. The main reason is the relatively high cost per check to the inquirer. The costs include long-distance charges and personnel charges. The personnel charge is relatively high per check because the job represents a part-time job. The number of checks of any one holder does not justify the costs of specialization, automation or training of personnel. There are likely to be as many different indicated banks as checks in hand for one holder, eliminating economies in calling. Access to complimentary databases for checks drawn on non-participating banks would be limited or nonexistent for most individual holders. Neither the accuracy nor the efficiency of necessarily un-trained un-specialized part-time employees is expected to be high. Utilizing the best time window for calling (say at least after 3:00 p.m. when paper checks should have cleared all accounts) and adding the constraint of not paying overtime (so the job is to be done by 5:00 p.m.) likely dictates utilizing a plurality of part-time employees. The cost of each such call for holders has been estimated to be at least over $2 per check, and very likely well over $3 per check. Thus, the procedure has historically been underutilized, and to the extent it has been utilized, it has been used sporadically, only for large checks. And of course, the less a system is used, the less cost effective it is per check.

The instant invention discloses and proposes an improved system for minimizing returned checks, including cost effectively securing account sufficiency information and/or related information for checks, an improved system that promises to render the inquiry procedure cost effective for essentially all sized checks. Tests have indicated that costs can drop as low as $1 or less, and possibly to 50 cents or less, or even lower, per check, where, say, 1000 or more checks are processed per night. (Or per session. The preferred embodiment envisions processing between 9:00 p.m. and 10:00 a.m. EST.) The invention discloses a specialized service provider organized for a timely, cost effective provision of account sufficiency and/or related information in regard to large numbers of checks from multiple holders or sources, a system designed to interface cost effectively with electronic clearing. Tests indicate that such a service provider, by specialization, can achieve efficiencies and economies of scale that will significantly reduce the cost of the procedure per check, to the level where it is generally cost effective. The information secured and/or provided to the holder can be more extensive, more timely, more accurate and less expensive than prior procedures. Systematically securing the information for all checks, thus, should become a cost effective solution. The system provider might even further enhance efficiencies by performing the electronic clearing.

To summarize the background of the invention, it is an object of the present invention to allow high risk check holders, such as non-face-to-face merchants like Web and Tel merchants who themselves create checks for their own payment, and collection agencies and the like, to reduce their risk of returned checks and enhance their likelihood of, and their speed of, payment. The instant invention will reduce the cost of, and enhance the viability of, commerce. Goods and services will be cheaper. The marketing of goods and services will increase.

In regard to merchants, while check verification and guarantee services offer face-to-face merchants, which comprise the majority of the business, a timely and cost effective means for securing an approval/disapproval rating for a check, the same is not true for the minority (at present) of non-face-to-face merchants.

The check verification and guarantee services' databases and algorithms are not fine-tuned for this segment of the market, the non-face-to-face merchant market, and the use of their databases and algorithms has not proven generally cost effective there. Thus, while check guarantee and verification services serve the needs of (and are cost effective for) the majority of the market, comprising rapid response to individual face-to-transactions, the non-face-to-face merchants could use cost effective information in helping decide whether to accept a check. (Collection agencies could also use this information.) Secondarily, non-face-to-face merchants and collection agencies could use better information in regard to the timing of the presenting of checks, in regard to attempting to clear checks.

Collection agencies, a class of holders of high risk checks, have historically fallen outside of the purview of the check verification/guarantee services offered. Indeed, check guarantee services have their own (or utilize third party) collection agencies. A collection agency's primary focus is on a more cost effective presentation, and clearing, of checks. Secondarily, of course, a collection agency could also utilize more detailed information in deciding whether to accept (i.e. acquire, purchase) checks, or for what price.

Recent banking regulations that limit the number of presentment and/or representment of both paper and electronic checks (presently to three [3]) puts additional pressure on collection agencies as well as Web and Tel merchants and other high risk holders who attempt to collect their own check. The risks of not collecting have gone up. The costs of collecting must go up. Thus, the costs of accepting such checks must go up and the cost of commerce concomitantly rises.

A bank phone inquiry system, to determine the existence of sufficient funds for a given check at that time, has been available for years, but the procedures required to utilize the system are so slow and cumbersome, in general, that the system has only been cost effective for, and thus and has only been utilized for, large checks.

Presumably for the same reasons, slowness and cumbersomeness as well as lack of completeness, the check verification and guarantee services have not depended on or systematically utilized the bank phone inquiry system. The known exceptions are for the very odd large check situation, or, in one known instance, to see if “after the fact” the services could measurably improve their databases.

The instant invention proposes to cost effectively (less than $1, probably less that 50 cents, possibly less than 35 cents,) preferably “overnight”, secure/supply account sufficiency information, and account sufficiency-related information, to the extent such information exists, to significantly improve a high risk check holder's decision to accept a check and ability to reduce the risk of a check's “return”, enhancing the likelihood of, and the speed of, receiving payment. The increased ability to use electronic clearing, permitting presentment and clearing of checks within a very short period of time, enhances the benefit of the instant invention

### SUMMARY OF THE INVENTION

Terms and Factors

The term “check holder” when used herein indicates a holder or owner or possessor, or an agent therof or thereto, of at least rights in a check, and one who has an interest in the clearing of the check. “Check holder” should be understood broadly to include agents operating therefore and subsidiaries of, or related companies thereto. A check holder has a clear vested interest in seeing that a check clears a bank, electronically, by paper or otherwise, and that the requisite party (usually itself) receives payment or credit. In a typical scenario, the check holder institutes the clearing process and controls its timing. If a check never clears, a check holder suffers monetarily, directly or indirectly. Such check holders, especially check holders at significant risk, become sources of records for the instant invention.

Reference to an electronic record should be understood to include electronic “or the like” records. Electronic records are the commonly used records of today but the system is not necessarily limited literally to electronic records. The invention could include optic or any other like records, when or if their use becomes available and feasible.

The source of account sufficiency information is the bank upon which the check is drawn, assuming such bank makes such information available. A significant percentage of banks, such as perhaps 60 percent (reflecting 30 to 45 percent of the checks,) some with additional restrictions, entertain a phone inquiry as to the sufficiency of funds for a given check. These banks are referred to as “participating” banks. In the process of responding to an inquiry, in addition to the sufficiency of funds or the lack thereof, a bank may further indicate that no account exists for the account indicator, or that an account exists in “bad standing” (overdrawn). Independent alternative databases exist for account sufficiency-related information, such as lists of valid/invalid account numbers for at least some banks. Such databases are particularly useful in regard to non-participating banks. Some such databases could feasibly augment even a primary source of account sufficiency information.

Banks, it should be understood, could use agents or independent providers to provide the inquiry service for them of rendering account sufficiency information. To the extent that such is done, the term “indicated bank” should be understood to cover such agents and/or service providers for them.

Account sufficiency information, as currently provided by a bank, includes an indication that, at the time of the inquiry, either there are sufficient funds in a valid account to cover the check (positive information) or there are not sufficient funds; it may include that the account indicator is not valid or that the account is in bad standing. Insufficient funds or invalid account or bad standing is referred to herein as negative information. Positive account sufficiency information (i.e. sufficient funds), secured after the close of a day's permitted clearing transactions, is particularly helpful in permitting the timing of a subsequent electronic presentation of a check, timed for the beginning of the next business day.

Banking hours typically end at 3:00 p.m. Federal Reserve clearing hours might end at 7:00 p.m. After banking hours and/or Federal Reserve hours, or after some other set deadline, there should be no further electronic or paper clearing of checks in an account until the beginning of the next business day. The only further hits upon an account that should occur are through ATM machines, and in common practice the totality of hits by an ATM machine on an account is at least limited for a given 24-hour period. (In an abundance of caution, an “inquiry” could add in a set amount in an “inquiry” to cover possible ATM activity.)

As discussed above, some banks permit inquiries in regard to multiple checks in a single call. Being able to organize calls, especially long-distance calls, to cover more than one check in a call is cost effective. Effecting cost reduction by handling a large volume of checks per day (or per night) (such volume as can be achieved by acquiring checks from multiple sources), is one of the economies of scale proposed for the instant specialized fund verification information provider.

The cost for long-distance phone calls to a plurality of banks can be a significant expense. Being able to utilize bulk long-distance phone rates, especially as provided by internet services for instance, further enhances the cost effectiveness of the invention. Such is another economy of scale possible for a fund verification service provider.

While callers can be human operators, they can also be partially or totally automated systems. Human operators who specialize in making bank calls can be trained, can improve their efficiency by repetition, and can be provided with automatic dialing capabilities and information screens to make the process quicker and more efficient. Training and repetition add speed and accuracy. Ultimately, a phone or electronic inquiry might be filly automated, including creating suitable automated capabilities to simulate and respond to audible tones, possibly thereby achieving the maximum cost effectiveness.

While it is anticipated that sources of check records will create and supply “inquiry” records at least from time to time, most sources will submit records daily. Some may submit weekly or on other periodic bases. Testing indicates that economies of scale, created by specialization and sorting, begin to take effect with an average of processing at least 1000 inquiries per day (or night), as per a preferred embodiment.

In a preferred system, records would be supplied to a service provider by an evening cutoff time, such as 9:00 p.m. Eastern Standard Time. The service provider would timely transmit a response to an indicated recipient, typically the record's source, within 12 to 14 hours. In one preferred embodiment the service provider would transmit a response by 10:00 a.m. Eastern Standard Time (next business day) for records supplied by 9:00 p.m. Eastern Standard Time.

Discussions of “daily” and/or within 12 hours or within 24 hours are to be understood herein to count only business days. Periods constituting non-business days, such as weekends and holidays, are not to be counted.

The instant invention offers an improved method for accessing account sufficiency information relating to bank checks. The invention includes creating an electronic record for a plurality of checks, each record indicating at least a check and a bank. Preferably the record indicates an amount, an account and a bank (or a bank clearing or routing mechanism, to be understood to be included in the term “bank”). The invention includes electronically transmitting a plurality of the records from a plurality of sources, or holders, to an account sufficiency information service provider. The invention includes ascertaining by the service provider, including at least by phone or electronic communication with an indicated bank, account sufficiency information in regard to at least 1000 checks per business day, on the average, relating to the records.

Preferably the invention includes essentially ascertaining the account sufficiency information at night, after banking hours, in order to permit electronic clearing of the check at the beginning of the next business day. Preferably also the invention includes sorting the records by bank to enhance the efficiency of the callers. Preferably also the invention includes automating, in part or in whole, the ascertaining efforts, or the callers, provided by the service provider.

### BRIEF DESCRIPTION OF THE DRAWINGS

A better understanding of the present invention can be obtained when the following detailed description of the preferred embodiments are considered in conjunction with the following drawings, in which:

FIGS. 1, 2 and 3 illustrate preferred embodiments of the instant invention.

The drawings are primarily illustrative. It would be understood that structure may have been simplified and details omitted in order to convey certain aspects of the invention. Scale may be sacrificed to clarity.

### DESCRIPTION OF THE PREFERRED EMBODIMENT

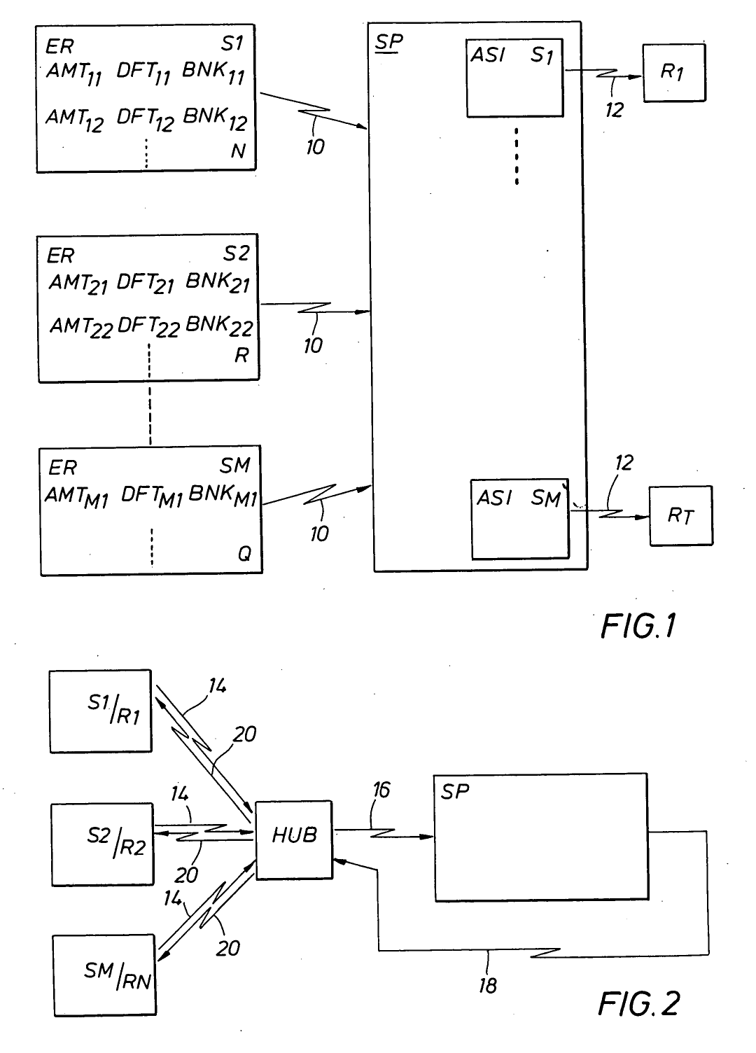

FIG. 1 illustrates a preferred embodiment of the instant invention. The boxes on the left in FIG. 1 relate to sources, named S1, S2 through SM. Each source creates an electronic record ER relating to that source. For a series of checks, checks 1 through N for source 1, checks 1 through P for source 2 and checks 1 through Q for source M, the electronic record contains an amount identifier, an account identifier and a bank or bank routing identifier for each check. Arrows 10 indicate the electronic transmission of the plurality of electronic records ER to service provider SP. When service provider SP has accumulated the account sufficiency information ASI relating to each record from a source, sources S1 through SM, (to the extent information exists) arrows 12 indicate the electronic transmission of the information to indicated recipients R1 through RT. (R1 through RT would typically be S1 through SM.)

FIG. 2 illustrates that the electronic transmission of information from sources S1 through SM might be electronically transmitted, as indicated by arrows 14, through a hub HUB and from the hub HUB electronically to the service provider SP, as indicated by arrows 16. Account sufficiency information and/or related information might be routed back, arrow 18, to hub HUB, and then, arrows 20, to sources S1 through SM (or recipients R1 through RT).

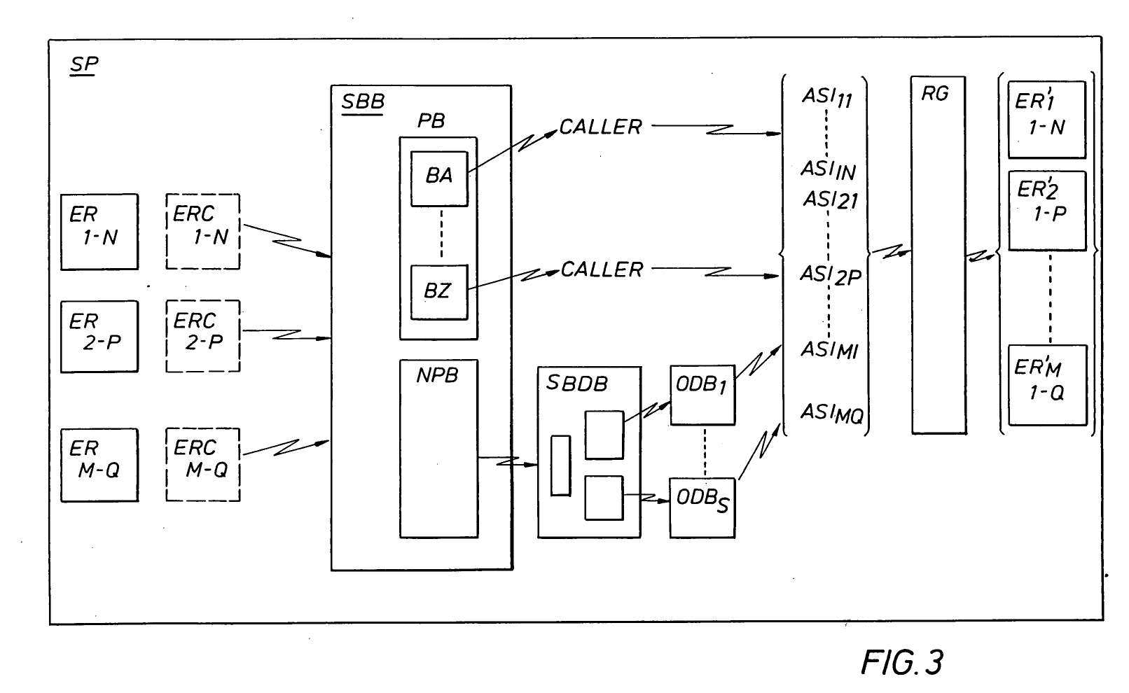

FIG. 3 breaks down and illustrates preferred activities of service provider SP. Copies of the electronic records, ERC (1-N), ERC (2-P), ERC (M-Q), are shown being funneled through a sort-by-bank sorter SBB. Individual check records from a plurality of sources can be sorted and organized by banks and assigned in that manner to callers. In a preferred embodiment the callers record account sufficiency information in regard to the checks for participating banks, with greater or lesser degree of automation. Checks relating to non-participating banks can be grouped and further sorted by available alternate databases, such as by a sorter SBDB. Inquiries for relevant checks can be made to “related information” databases OPB₁ to ODB₈. All account sufficiency and related information, by check, can be processed through report generator RG, repackaged, and returned to the source or indicated recipient.

The service provider itself could provide electronic clearance of checks for sources, as an additional option.

As an additional feature, the service provider, once in the business, could offer to respond in real time to individual inquiries.

The foregoing description of preferred embodiments of the invention is presented for purposes of illustration and description, and is not intended to be exhaustive or to limit the invention to the precise form or embodiment disclosed. The description was selected to best explain the principles of the invention and their practical application to enable others skilled in the art to best utilize the invention in various embodiments. Various modifications as are best suited to the particular use are contemplated. It is intended that the scope of the invention is not to be limited by the specification, but to be defined by the claims set forth below. Since the foregoing disclosure and description of the invention are illustrative and explanatory thereof, various changes in the size, shape, and materials, as well as in the details of the illustrated device may be made without departing from the spirit of the invention. The invention is claimed using terminology that depends upon a historic presumption that recitation of a single element covers one or more, and recitation of two elements covers two or more, and the like. Also, the drawings and illustration herein have not necessarily been produced to scale.

1. An improved method for accessing account sufficiency information related to checks, comprising:
creating an electronic record for a plurality of checks, each record indicating at least a check and a bank;
electronically transmitting a plurality of said records from a plurality of sources to an account sufficiency information service provider; and
ascertaining by the service provider, including at least by phone or electronic communication with an indicated bank if it is participating, account sufficiency information in regard to at least 1000 checks per business day, on average, relating to said records.

2. The method of claim 1 that includes electronically transmitting the ascertained account sufficiency information to an indicated recipient.

3. The method of claim 1 that includes instituting an electronic clearance of a plurality of bank checks within 12 hours of ascertaining by the service provider sufficient funds information in regard to the checks.

4. The method of claim 3 that includes electronically transmitting the account sufficiency information to an indicated recipient.

5. The method of claim 2 that includes instituting an electronic clearance of a plurality of bank checks by the indicated recipient within 12 hours of ascertaining sufficient funds information in regard to the checks by the service provider.

6. The method of claims 2 or 5 wherein the indicated recipient is the source of the record for the check.

7. The method of claim 1 wherein the transmitting includes transmitting daily.

8. The method of claim 1 wherein the creating includes creating at least weekly.

9. The method of claim 1 wherein the plurality of sources includes at least one collection agency, Tel seller, Web seller and check guarantee/verification provider.

10. The method of claim 2 that includes communication by the service provider with at least one database of account sufficiency-related information and transmitting the account sufficiency-related information to the indicated recipient.

11. The method of claim 2 wherein the transmitting of account sufficiency information in regard to a check includes transmitting within 24 hours of a prior transmitting of a record indicating the check.

12. The method of claim 2 wherein the transmitting of account sufficiency information in regard to a check includes transmitting within 13 hours of a prior transmitting of a record indicating the check.

13. The method of claim 1 wherein the ascertaining by at least phone or electronic communication with an indicated bank includes ascertaining after banking hours.

14. The method of claim 1 wherein the ascertaining by at least phone or electronic communication with an indicated bank includes ascertaining after the bank's daily deadline for clearing checks.

15. The method of claim 1 wherein the ascertaining includes ascertaining, in a single phone or electronic communication with an indicated bank, account sufficiency information for at least two checks transmitted from different sources.

16. The method of claim 1 that includes establishing, by the service provider, a plurality of bank accounts at participating banks.

17. The method of claim 1 that includes establishing a contractual relationship between the service provider and a plurality of participating banks.

18. The method of claim 1 that includes ascertaining using internet phone.

19. The method of claim 1 that includes providing a caller of the service provider with an automated dialing capability to an indicated bank.

20. The method of claim 1 wherein ascertaining includes utilizing an automated phone calling system, the calling system simulating and responding to audible tones.

21. The method of claim 1 that includes electronically presenting a check for which account sufficiency information was ascertained within one hour of the opening of banking hours of the banking day subsequent to a time of the ascertaining.

22. The method of claim 1 that includes maintaining and updating a database in regard to account sufficiency information by the service provider.

23. The method of claim 2 that includes authorizing a shipment of goods and/or a supply of services in response to a transmitting of account sufficiency information.

24. An improved method for utilizing account sufficiency information related to check acceptance, comprising:
creating an electronic record indicating at least a non-face-to-face check and a bank;
electronically transmitting the record to an account sufficiency information service provider;
ascertaining by the service provider, including at least by phone or electronic communication with the indicated bank if it is participating, account sufficiency information in regard to the check; and
electronically transmitting account sufficiency information to an indicated recipient within one minute of the said electronic transmission.

25. An improved method for presenting checks, comprising:
receiving a plurality of electronic records from a plurality of check holders at an account sufficiency information service provider, each record indicating at least a check and a bank;
ascertaining by the service provider, by at least phone or electronic communication with the indicated banks that are participating, account sufficiency information in regard to at least 1000 checks per business day, on average, from the plurality of holders; and
subsequently electronically clearing a plurality of checks associated with a plurality of holders for which positive account sufficiency information was ascertained, by the end of a banking business day subsequent to the time to of the ascertaining.

26. The method of 25 wherein the ascertaining takes place subsequent to a daily deadline for clearing checks for a banking business day.

27. The method of claim 1 wherein the creating is by one of the plurality of sources who is a holder of the check.

28. The method of claims 1, 24 or 25 wherein indicating at least a check and a bank includes indicating an amount, an account and a bank or bank routing system.

29. The method of claim 25 that includes electronically clearing by the service provider.
